(19) United States
(12) Patent Application Publication
(10) Pub. No.: US 2025/0327192 A1
(43) Pub. Date: Oct. 23, 2025

(54) IMPROVEMENTS RELATING TO HYDROGEN ELECTROLYSIS SYSTEMS

(71) Applicant: VESTAS WIND SYSTEMS A/S, Aarhus N (DK)

(72) Inventors: Ionut TRINTIS, Østbirk (DK); Anders TUXEN, Risskov (DK); Philip Carne KJÆR, Aarhus C (DK)

(21) Appl. No.: 19/121,529

(22) PCT Filed: Nov. 1, 2023
(86) PCT No.: PCT/DK2023/050263

§ 371 Date: Apr. 16, 2025

(30) Foreign Application Priority Data
Nov. 1, 2022 (DK) PA202270530

(51) Int. Cl. C25B 1/04; C25B 15/023; F03D 9/19

(52) U.S. Cl. CPC C25B 1/04; C25B 15/023; F03D 9/19; F05B 2220/61

(57) ABSTRACT

A hydrogen generation system comprising a hydrogen electrolyser, a power converter connected to the electrolyser, and a control system configured to control the power converter to supply power to the electrolyser The system further includes a monitoring system configured to monitor the operation of the generation system, wherein the monitoring system is configured to: determine a plurality of operational parameters of the electrolyser, and, generate one or more performance metrics based on the determined operational parameters, the one or more performance parameters including: the electrical capacitance of the electrolyser, and/or the equivalent series resistance of the electrolyser. Also disclosed is a method for determining operational performance of a hydrogen generation system including an electrolyser.

### TECHNICAL FIELD

The invention relates to a system for hydrogen electrolysis and a method for operating an electrolysis system.

### BACKGROUND

It is known that hydrogen is a highly effective energy carrier which results in no CO2 emissions when energy is released. It can be readily stored and transported making it a viable alternative to fossil fuels such as petrol and diesel. However, hydrogen production via water electrolysis requires a tremendous amount of electricity thereby potentially reducing the positive environmental impact of moving to hydrogen fuel.

Hydrogen produced by renewable energy sources such as wind or solar power is the environmental ideal since no fossil fuels are used in its production. Hydrogen produced in this way is known as green hydrogen. However, because wind and solar power production is dependent on ever changing environmental conditions, it is difficult in practice to produce hydrogen efficiently from these power sources. Despite these challenges, electrolysis of water using renewable energy sources has great potential. A particularly efficient arrangement is to connect an electrolyser directly to the generator of a wind turbine in a DC-coupled connection. Such an arrangement can potentially provide many advantages in terms of lower cost due to the omission of a grid transformer and switchgear, and improved electrical efficiency as fewer power electronics need to be used. However, a practical challenge is that over time an electrolyser stack will degrade. Stack degradation can occur through various mechanisms, such as catalyst agglomeration and poisoning, internal corrosion and membrane puncturing and scission. Commercially available approaches to monitoring stack health tend to be rudimentary and it would be desirable to assess electrolyser stack health in a more accurate and predictable way. It is against this background that the present invention has been developed.

### SUMMARY OF THE INVENTION

In a first aspect, the examples of the invention provide a hydrogen generation system in accordance with claim 1. In a second aspect, the examples of the invention provide a method in accordance with claim 9.

Preferred and/or optional features are set out in the dependent claims.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described, by way of example only, with reference to the accompanying drawings, in which:

FIG. 1 is a schematic view of a wind turbine in which a hydrogen generation system in accordance with the invention may be incorporated;

FIG. 2 is a schematic view of the of a hydrogen generation system in accordance with an embodiment of the invention;

FIG. 3 is a schematic view which shows more details of an electrolyser of the hydrogen generation system in FIG. 2;

FIG. 4 is a schematic view of a condition monitoring system of the hydrogen generation system of the invention;

FIG. 5 is a flow chart illustrating an example of a condition monitoring algorithm that may be implemented by the condition monitoring system of FIG. 4;

FIG. 6 is a further illustration of aspects of the condition monitoring algorithm of FIG. 5.

### DETAILED DESCRIPTION

The following detailed description refers to the accompanying drawings that show, by way of illustration, specific details and embodiments in which the invention may be practiced. These embodiments are described in sufficient detail to enable those of ordinary skill in the art to practice the invention. Other embodiments may be utilised, and structural changes may be made without departing from the scope of the invention as defined in the appended claims.

The following disclosure introduces the technical context of the invention through a discussion of an electrolysis system coupled to a wind turbine system and, and also discusses further detail of a possible type of electrolyser configuration, for completeness, although it should be noted that the examples give are exemplary only and are not intended to limit the scope of the invention as defined in the claims. Following the introductory discussion of the technical context of the invention, the disclosure focuses more specifically on approaches for monitoring operation of the electrolysis system, deriving performance and health data from the monitored operation, and taking action based on the performance and health data.

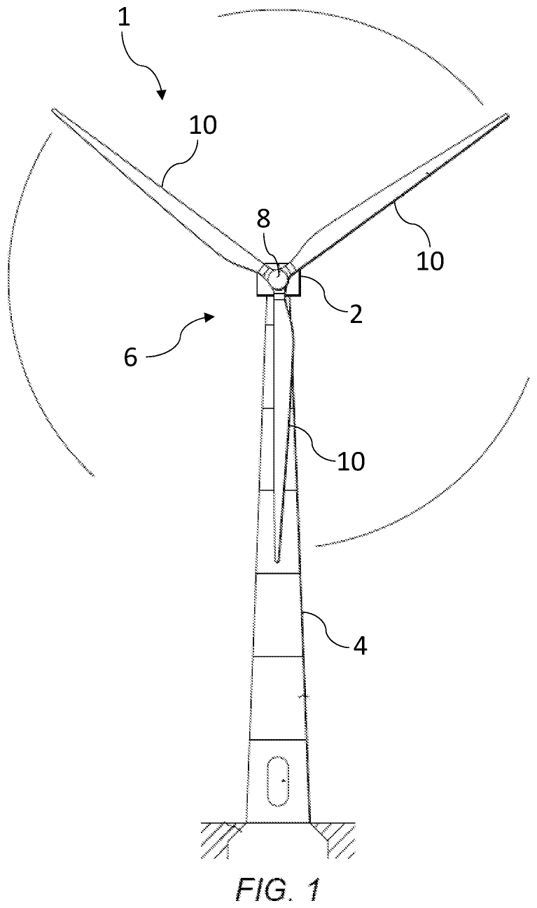

FIG. 1 shows a schematic view of a wind turbine 1 in which the invention may be incorporated. The wind turbine 1 includes a nacelle 2 that is supported on a generally vertical tower 4. The nacelle 2 supports a main rotor arrangement 6. The main rotor arrangement 6 comprises a hub 8 and a plurality of wind turbine blades 10 connected to the hub 8. In this example, the wind turbine 1 comprises three wind turbine blades 10. The wind turbine 1 in FIG. 1 is a well-known horizontal-axis wind turbine which is the most common form of large-scale wind turbine, but other formats would be acceptable for the invention.

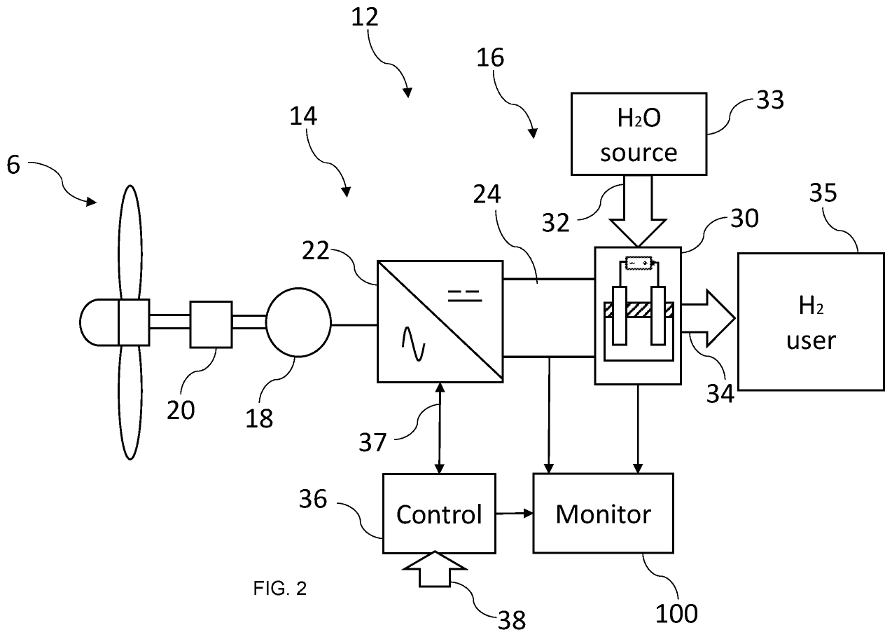

The nacelle 2 also houses many functional components of the wind turbine. Typically, such a wind turbine 2 would be used to generate electrical energy in AC or DC form for supply to an associated electrical distribution grid. However, in this embodiment of the invention the wind turbine 1 incorporates an integrated hydrogen generation system that uses the electrical power generated by a generator housed inside the nacelle 2 into stored energy in the form of hydrogen gas by an electrolysis system.

Whereas FIG. 1 illustrates a typical wind turbine in which the invention can be implemented, FIG. 2 shows a systems-level overview of a hydrogen generation system 12 in accordance with an embodiment of the invention.

In overview, the hydrogen generation system 12 comprises a power generation system 14 which is coupled to an electrolysis system 16. Although the main focus of this disclosure is to green hydrogen generation, in some examples the electrolysis system 16 may be connected to the grid or a source of non-renewable energy. This is known generally as grey hydrogen generation.

The power generation system comprises the main rotor arrangement 6, hereinafter called simply the ‘rotor’, which drives an electrical generator 18 through a gearbox 20. It is to be noted that although a gearbox is a component that is typical in utility-scale wind turbine generators, systems are also known that are based on a so-called direct drive architecture which do not use a gearbox. The embodiments of the invention are applicable to both types of systems.

The generator 18 is electrically connected to a power converter system 22. Typically, the generator 18 and the primary power converter system 22 would operate on a three-phase electrical architecture, although this is not essential.

The primary power converter system 22 provides a DC input power source to the electrolysis system 16 by way of a DC link 24. The skilled person would appreciate that the power primary converter system 22 and the DC link 24 in effect comprise half of what would usually be understood as a full-scale back-to-back power converter system architecture that is common in utility-scale wind turbines for the provision of variable frequency electrical power and associated reactive power support. However, in the system of the invention, only a single power converter system 22 is used to convert the AC power output by the generator 18 into DC power that is provided to the DC link 24 for supply to the electrolysis system 16. The electrolysis system 16 is therefore directly coupled to the power converter system 22 by the DC link 24. The precise form of converter implemented as the primary power converter system 22 would be within the capabilities of the skilled person. At a basic level the primary power converter system 22 may be implemented as a passive rectifier unit, which is preferably three-phase in in utility-scale applications. Such a rectifier may be implemented with suitable semi-conductor devices such as diodes and/or thyristors, or it may be implemented in a more sophisticated manner with transistor-based switching devices. The choice of current switching device such as diodes, thyristors and semi-conductor switches is within the capabilities of a skilled person.

It should be noted at this point that the system view of FIG. 2 is schematic in form so does not represent a complete practical system, which may include other components such as power inductors, chokes, filters, isolation switches, power dissipation choppers, breakers and so on. However, such system components are within the purview of a skilled person and so are not discussed in detail in this disclosure.

Turning to the electrolysis system 16 in more detail, in overview that system comprises an electrolysis cell stack or ‘electrolyser’ 30. The electrolyser 30 is fed with an input water stream 32 by an appropriate water source 33. That water source 33 may supply fresh water, for example from storage tanks or from a pipe. Alternatively in the case of a system based offshore, a de-saliniser may be used to remove salts from seawater and supply fresh water to the electrolyser 30. Such a de-saliniser is a known system that would be understood by the skilled person and so a full technical description will not be provided here.

The electrolyser 30 provides a hydrogen output stream 34 to a user 35 of the generated hydrogen. The user 35 may be a direct supply to a distribution network, or it may be a suitable storage capacity such as a set of tanks. The hydrogen user 35 may also include a suitable compressor/dryer system to compress the hydrogen to a suitable pressure level (e.g. 700 bar) before. In this embodiment, the electrolyser 30 may be of the type to provide non-pressurised hydrogen, that is to say hydrogen at substantially atmospheric pressure, such that a compressor is required to pressurise the hydrogen output stream for usage and/or storage purposes. However, in examples where the electrolyser is a high pressure system, then a compressor may not be required, as would be understood by a skilled person.

The hydrogen generation system 12 also comprises a control system 36. The control system 36 is shown here as a single functional block for simplicity, although it should be noted that this is not intended to infer any physical or logical restrictions on the actual implementation of the control system 36. As such, the control system 36 may be implemented as a standalone computing device which is configured to communicate via a wired or wireless connection with the systems, sub-systems, sensing units and so on under its control. The control system 36 may also be implemented as distributed control units, for example to provide redundancy. The precise physical and logical implementation of the control system 36 is not central to the invention and so a detailed discussion is outside the scope of this disclosure.

The control system 36 is coupled to the power converter 22 by at least one control channel 37 in order to control the output power that is delivered to the electrolyser 30 over the DC link 24. The control channel 37 is also configured to return sensing information to the control system 36 that it may need to perform its control objectives. The control system 36 is also configured to receive data input 38 from other sources. Such data input may include: pitch angle of one or more blades of the rotor, rotational speed of the generator and wind speed.

At this point, it should be noted that in principle any suitable type of electrolyser 30 may be used, the specification of which would be within the understanding of a skilled person. For instance, the electrolyser may be an alkaline electrolyser, a polymer-electrolyte membrane (PEM) electrolyser, or an solid-oxide electrolyser (SOEC), by way of example.

In the illustrated embodiment the electrolyser includes structure and functionality which means that the number of active cells within the electrolyser 30 can be varied.

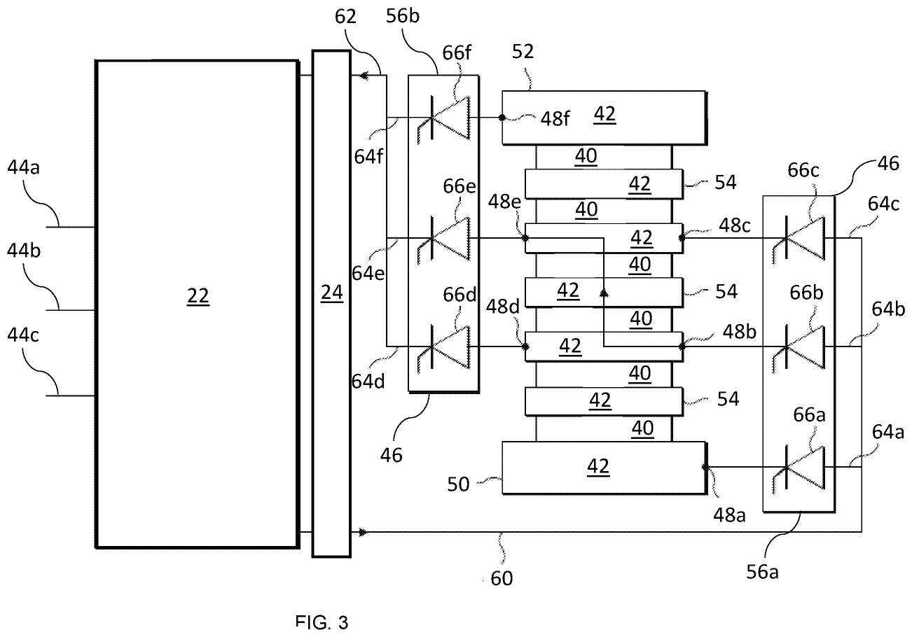

The electrolyser 30 is shown in more detail in FIG. 3, also in schematic form. With reference to FIG. 3, it can be seen that the electrolyser 30 comprises a plurality of electrolysis cells 40 arranged in a stack. Each of the electrolysis cells 40 comprises a pair of electrodes 42 for carrying electrical current to and from the electrolysis cells 40 in use. The electrodes 42 located between adjacent cells 40 in the stack may be electrically connected to one another via an intermediate electrical conductor so that current may flow in series between the cells 40 in the stack. Alternatively, the electrodes 42 located between adjacent cells 40 may abut one another or may be integral with one another. The electrodes 42 of adjacent cell 40 in the stack may therefore be referred to as being electrically adjacent.

As can be seen in FIG. 3, the three phases of AC power produced by the generator are connected to the primary power converter 22 by respective electrical conductors 44a, 44b, 44c. The AC current from the generator is converted to DC current by the power convertor 22 and supplied to the DC link 24.

The primary power converter 22 is connected to the electrolyser 30 by way of a switching module 46. For the purpose of this discussion, the switching module 46 may be considered to be part of the electrolyser 30. The switching module 46 has an appropriate structure and provides appropriate connections to operate cells 40 in the stack selectively. The switching module 46 will now be described in more detail.

The electrolyser 30 comprises a plurality of electrical connectors 48a, 48b, 48c, 48d, 48e, 48f which are connected to selected electrodes 42 of the electrolysis cells 40 forming the stack. The first electrical connector 48a is connected to the input electrode 42 of the electrolysis cell 40 located at a first end 50 of the electrolyser 30 and the sixth electrical connector 48f is connected to the output electrode 42 of the electrolysis cell 40 located at a second end 52 of the electrolyser 30.

The second and fourth electrical connectors 48b, 48d are connected to a first pair of electrically adjacent electrodes (which may be integral) part way along the stack of electrolysis cells 40, and the third and fifth electrical connectors 48c, 48e are connected to a second pair of electrically adjacent electrodes (which may be integral) a further part way along the stack of electrolysis cells 40. Thus, the electrolyser 30 may be split into three independently operable sections 54 depending on how the electrical connections to the electrolyser 30 are made.

In this embodiment the switching module 46 is embodied by two banks 56a,56b of switches, which are illustrated as thyristors although the skilled person would appreciate that other switch means would be appropriate, for example other semiconductor switching devices such as MOSFETs, JFETs, IGBTs and so on. The DC link 24 is connected to the electrolyser 30 by way of the switching banks 56a,56b.

The DC link 24 is connected across the electrolyser 30 by a pair of electrical conductors 60, 62. A first one of the pair of electrical conductors 60 is connected to the first switching bank 56a, which provides three selectively controlled branch electrical conductors 64a, 64b, 64c. Similarly, the second of the pair of electrical conductors 62 is connected to the second switching bank 56b which provides three selectively controlled branch electrical conductors 64d, 64e, 64f. Each of the branch electrical conductors 64a, 64b, 64c, 64d, 64e, 64f is selectively connectable to an electrode 42 of the electrolyser 30 via thyristors 66a, 66b, 66c, 66d, 66e, 66f.

The first branch conductor 64a is connected to the first electrical connector 48a via thyristor 66a. Similarly, the sixth branch conductor 64f is connected to the sixth electrical connector 48f via thyristor 66a. The second and fourth branch conductors 64b, 64d are connected to the second and fourth electrical connectors 48b, 48d via thyristors 66b, 66d respectively, and the third and fifth branch conductors 64c, 64e are connected to the third and fifth electrical connectors 48c, 48e via thyristors 66c, 66e respectively.

As is well known in the art, current may only pass through a thyristor when a small control current is applied to the gate of the thyristor. Thus, the thyristors 66a-f constitute electronic switches which selectively allow electrical connection of the branch conductors 64a-f to the electrical connectors 48a-f of the electrolyser 30. It is therefore possible to selectively operate different parts of the electrolyser 30 in dependence on the amount of power being provided by the generator as will be described in greater detail below.

For example, in use if the power provided by the generator 18 to the electrolyser 30 is at or above a first predetermined power output, e.g. 15%, of the rated maximum nominal load of the electrolyser 30, the entire length of the stack of electrolysis cells 40 forming the electrolyser 30 can be activated or ‘energised’. This is achieved by applying a control current to the gates of the first and sixth thyristors 66a, 66f to allow current to flow from the first end 50 to the second end 50 of the electrolyser 30 thereby utilising every electrolysis cell 40 in the stack. Alternatively, should the power available from the generator 18 be below 15% of the rated maximum nominal load of the electrolyser 30 the number of active electrolysis cells 40 can be reduced by selective operation of the thyristors 66a to 66f.

For example, if the power available from the generator 18 is less than the first predetermined power output (e.g. 15% as discussed above) but greater than or equal to a second predetermined power output (e.g. 10% of the rated maximum nominal load of the electrolyser 30) a control current may be applied to the gates of the first and fifth thyristors 66a, 66e to allow current to flow from the first end 50 through the first and second sections of the stack of cells 40, so that those activated cells experience a current flow above the threshold, even though the operating power is lower than the threshold of the whole electrolyser 30. Alternatively, a control current may be applied to the gates of the second and sixth thyristors 66b, 66f to allow current to flow through the second and third sections of the of the stack of cells 40 forming the electrolyser 30.

As another operational example, if the power available from the generator 18 is less than the second predetermined threshold, e.g. 10%, and greater than or equal to a cut-off minimum power of the rated maximum nominal load of the electrolyser 30, a control current may be applied to the gates of the first and fourth thyristors 66a, 66d to allow current to flow from the first end 50 through only the first section of the of the stack of cells 40. Alternatively, a control current may be applied to the gates of the second and fifth thyristors 66b, 66e to allow current to flow through only the second section of the of the stack of cells 40. In a further alternative, a control current may be applied to the gates of the third and sixth thyristors 66c, 66f to allow current to flow through only the third section of the of the stack of cells 40.

From the above discussion, therefore, it will be appreciated that the switching module 46 can be controlled to regulate the number of cells of the electrolyser 30 that are energised in dependence on various operational parameters-e.g. the power output of the generator or the power available from the wind-in order to maintain the electrolyser stack in a more efficient state of operation in which current density to the cells is controlled to maximise H2 production. It should be noted that operational control of the thyristors 66a-f is provided by the control system 39.

Having described the schematic overview of the hydrogen generation system 12 with reference to FIGS. 2 and 3, the discussion will now turn to specific functionality features of the hydrogen generation system 12.

As shown in FIG. 2, the hydrogen generation system also includes a condition monitoring system 100. The functionality of the condition monitoring system 100 is to measure the performance of the hydrogen generation system 12 and to generate alerts, advisories or warnings if the system is operating sub-optimally such that some action may be taken to improve its performance. The advisories may relate to the performance of the overall electrolyser, or components thereof, such as at least one of an anode component, a cathode component and an electrolyte component of the electrolyser.

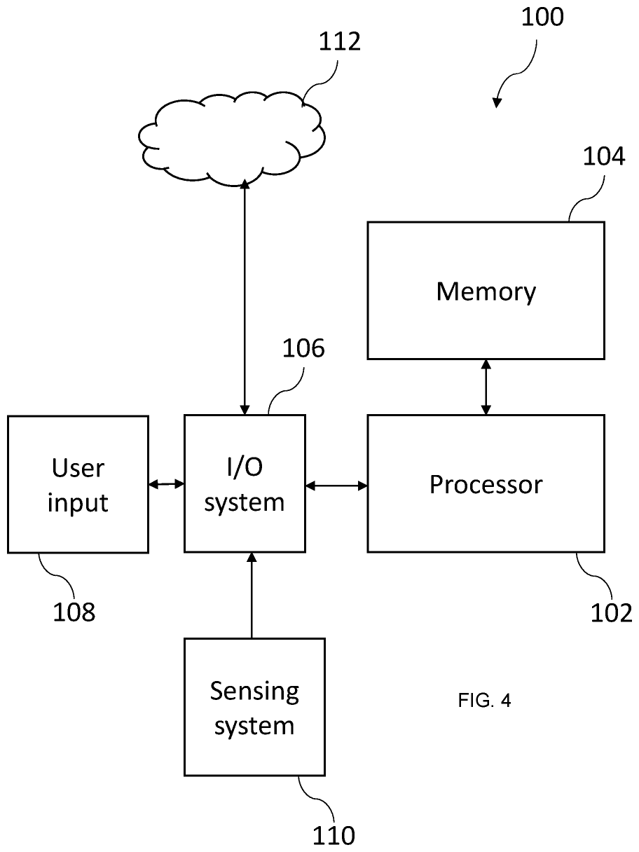

The condition monitoring system 100 is shown in more detail in FIG. 4 and comprises suitable computing components to enable the condition monitoring system 100 to function suitably so as to be capable of performing the methods described here.

In overview, the condition monitoring system 100 includes central computing system or processor 102 that is suitably coupled to a memory unit or data store 104, and an input/output system 106 which acts as the interface between the processor 102 and other computing components.

The processor 102 shown here is representative of a single processor having one or more processing cores, or multiple processors acting together for a functional objective. Likewise, the data store 104 may take on any appropriate memory format, including volatile and non-volatile memory, solid state storage, magnetic disk, optical disk, non-removable and removable storage, network/cloud storage and so on.

The input/output system 106 may be any suitable configuration to allow the external peripherals and connections to communicate with the processor 102. As shown here, the input/output system 106 is coupled to a user input system 108, a sensing system 110 and a communications network 112.

The user input system 108 may be any suitable form for providing to the condition monitoring system 100. For example, the user input system 108 may comprise a keyboard, a display screen and a mouse, or a touch sensitive display, an installed terminal, a remote terminal and so on, as would be understood by a skilled person.

The sensing system 110 may comprise any suitable sensors that the condition monitoring system 100 can use to gather data from in order to carry out the monitoring functionality. For example, therefore, the sensing system 110 may take data feeds from voltage sensors, current sensors, timers, wind speed and direction sensors, grid stability sensors and so on. Suitable edge processing capability may be provided in the sensing system 110 to provide compound/processed data types by carrying out initial processing on raw data received by sensors.

The communications network 112 may be any suitable network, for example a local area network (LAN) connecting multiple computing devices over a relatively narrow geographical spread, or a wide area network for example. As such, the communications network 112 may be the internet. Alternatively, the communications network 112 may be a SCADA (supervisory control and data acquisition) network within a wind park.

From the above discussion, it will be noted that the computing architecture of the condition monitoring system 100 may be satisfied by a general purpose computing system, either as a single physical module or suitably distributed in a suitable manner. It may also be fulfilled by the main computer control system (not shown) for the wind turbine.

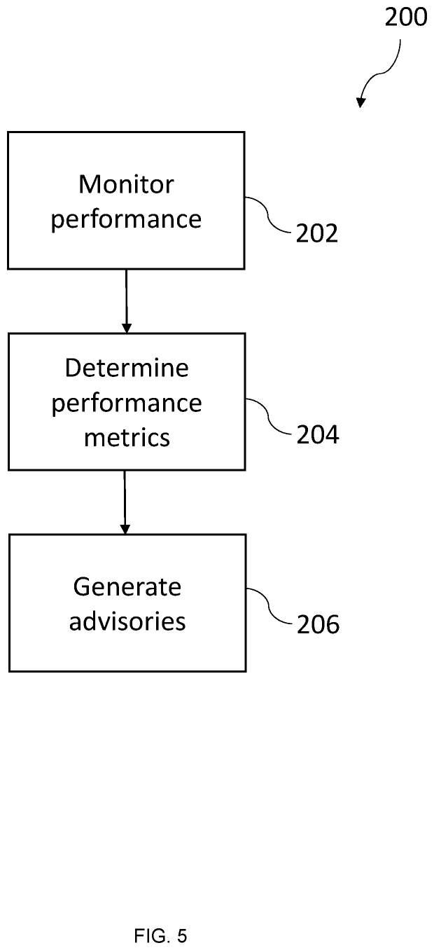

The condition monitoring system 100 implements appropriate algorithms to monitor and report on the performance of the electrolysis system 16 and to recommend appropriate remedial actions. As shown in FIG. 5, an algorithm 200 in accordance with an example of the invention includes monitoring 202 the performance of the electrolysis system, determining 204 a set of metrics from the performance monitoring, and generating 206 one or more advisories based on the performance metrics so that appropriate action can be taken regarding the operation of the electrolysis system 16.

In general, the step of monitoring 202 the performance of the electrolysis system 16 may involve determining a plurality of operational parameters of the electrolyser that can be used to calculate or infer the efficiency with which the electrolyser is converting electrical energy provided by the generation system into hydrogen. For example, the condition monitoring system 100 may determine the voltage and current with which the electrolyser 30 is being supplied, and the volume of hydrogen that is being produced. By comparing the electrical energy being consumed by the electrolyser, indicated by the product of input voltage and current, with the volume of hydrogen that is produced, it is possible to derive an efficiency metric for the electrolyser. By trending such a metric over a predetermined time period, it is then possible to track the energy efficiency of the electrolyser and also the rate of deterioration. Suitable efficiency thresholds can be implemented to trigger advisory actions when the efficiency metric has reached one or more predetermined thresholds. The advisory actions may include a recommendation or call to action messages, hereinafter referred to as ‘action messages’ to conduct maintenance on the electrolyser e.g. by replacing a component part thereof, that is to say a component replacement recommendation.

The action messages may be stored in memory for access by maintenance personnel at a suitable time. The action messages may be stored in a suitable action log or database. Action messages may be generated and suitably transmitted to actors involved with the condition monitoring system 100. For example, the action messages may be transmitted to a remote computing device which may be in a control centre associated with the electrolysis system, for example which may be managed by a company tasked with managing the hydrogen electrolysis system. Alternatively, action messages may be in the form of commands intended to trigger automated repair systems.

As discussed above, the efficiency of the electrolyser may be assessed by the relatively simple process of comparing the electrical energy consumed by the electrolyser over a certain time period e.g. in kWh, compared with the chemical energy represented by the volume of hydrogen produced by the electrolyser in the time period e.g. in cubic meters. Such an analysis provides a comparatively rough estimation of the efficiency of the system.

The following examples or use cases provide the opportunity to gain further insight into the operational health of the electrolysis system.

In a first example, the condition monitoring system 100 is configured to determine the performance metric of electrical capacitance of the electrolyser. The metric of electrical capacitance is believed to provide a more accurate metric to assess the health of the electrolyser.

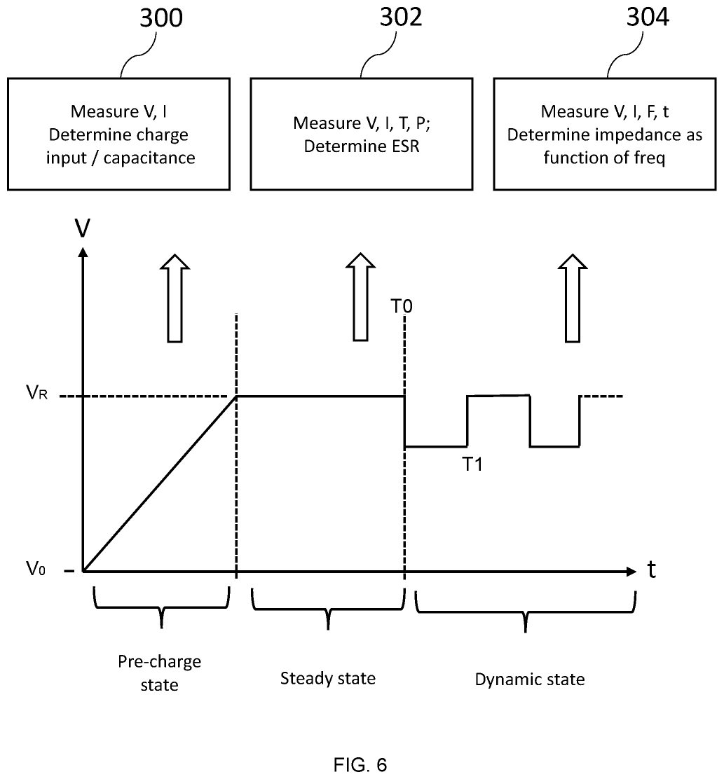

The electrical capacitance of the electrolyser may be calculated by determining an amount of charge delivered to the electrolyser during a pre-charge phase. As would be understood by the skilled person a pre-charge phase is the period during which the voltage on the electrolyser is brought up to an operational level, during which time the electrolyser operates as a capacitor and absorbs charge without generating hydrogen. A pre-charge phase or state is shown in FIG. 6 on the left of the graph where voltage is increased from VO to VR.

The condition monitoring system 100 is therefore configured to monitor the operational parameters of voltage applied to the electrolyser and the load current consumed by the electrolyser until such time that the voltage reaches an operational threshold voltage or ‘rated’ voltage VR, as shown on FIG. 6 at step 300.

The condition monitoring system 100 is further configured, at step 300, to determine the capacitance of the electrolyser by integrating the measured load current consumed by the electrolyser in the time period from when the voltage is applied to the electrolyser until the electrolyser is at its rated voltage level. In this way, the monitoring system 100 calculates the charge delivered to the electrolyser.

Once the condition monitoring system 100 has calculated the charge delivered to the electrolyser it is able to calculate its capacitance, e.g. in Farads. This data can thus be recorded in memory as a data point. This process may be repeated every time the electrolyser is cycled between non-operating and operating states. In the context of a renewable energy driven electrolysis system, it is likely that the electrolyser will be ‘powered up’ on a relatively frequent basis because the energy availability of the wind means that there will be periods where wind power in insufficient to power the electrolysis system which therefore needs to be taken offline into a non-operating or ‘standby’ state.

However, the electrolysis system 16 can be brought online into an operating state when it is detected that the wind power is sufficient for stable electrolyser operation. The process of determining the capacitance of the electrolyser during a pre-charge phase can therefore be carried out each time, or most times, the electrolyser is energised into an operating state and the calculated capacitance value can be recorded as further data points in an appropriate data structure in memory.

Since the capacitance of the electrolyser is believed to be a more accurate metric of the performance and health of the electrolyser, suitable statistical analysis can be carried out on the capacitance data points to derive insight into the electrolyser efficiency so that appropriate action can be taken. For example if it is detected that the electrolyser capacitance is gradually reducing over time, predictive maintenance can be scheduled for the electrolyser to be serviced or replaced at a future date.

Conversely, if the electrolyser capacitance has been observed to reduce at an increased rate of change, a maintenance action can be triggered for the electrolyser to be serviced or replaced at a relatively early point in time.

In the context of the electrolyser configuration described above, an enhancement to this process would be to calculate the capacitance for individual ones of the plurality of cells of the electrolyser. This would enable a more granular data set of capacitance values to be calculated to provide greater insight on the cell-by-cell health of the electrolyser.

This could be achieved during a pre-charge phase in which individual cells are energised and brought up to their rated voltage level whilst monitoring the current flow into that specific electrolyser cell. The process may be repeated for the other cells in the electrolyser in order to build up an enhanced data-driven knowledge base of cell capacitance as well as the total or bulk capacitance of the electrolyser.

Determination of the capacitance of the electrolyser may be used to determine and monitor the state of the electrolyser, given that the electrolyser capacitance in general will be a function of a number of parameters of the electrodes in the electrolyser such as but not limited to electrode surface area, ionic composition, electrode contamination by water impurities and electrode corrosion. For an electrolyser based on membrane technology such as PEM (proton exchange membrane) or AEC (anion exchange membranes) the recorded capacitance may further be used to determine changes to the properties and health of the membrane.

The first example of electrolyser monitoring discussed above was carried out during a pre-charge state, as shown in FIG. 6.

A second example of electrolyser monitoring is appropriate to be carried out during steady state operation, as also shown in FIG. 6.

In this example, the condition monitoring system 100 is configured to determine the performance metric of electrical series resistance of the electrolyser during steady state operation as shown in step 302. By the term steady state operation, it is meant that the input voltage applied to the electrolyser does not significantly change from its rated level, e.g. it does not vary by greater than more than 5% per minute.

During this monitoring process, the condition monitoring system 100 is configured to measure the applied voltage of the electrolyser and the consumed current, from which operational parameter values of resistance can be calculated. To enhance accuracy, the resistance data points may be recorded with measurements of further operating parameters of the electrolyser such as internal operating temperature and internal operating pressure.

From the measurements of operational parameters including voltage, current, temperature and pressure, a performance metric of equivalent series resistance (ESR) of the electrolyser can be calculated as a function of temperature and/or pressure.

Repeated calculation of electrolyser ESR provides a plurality of data points which can suitably be stored in memory. The ESR data points may be analysed to identify trends which would enable defects or degradation within the electrolyser to be identified and for appropriate maintenance actions to be triggered.

A third example of electrolyser performance monitoring will now be described. Whereas the first example discussed above targeted a pre-charge phase of the electrolyser, and the second example targeted a steady state operation of the electrolyser, the third example focuses on a dynamic response state of the electrolyser. In FIG. 6, this approach is indicated by ‘dynamic state’ and is shown temporally following the steady state section of the graph. However, it should be understood that the dynamic state may be carried out at any time.

During the dynamic state, the condition monitoring system 100 is configured to apply a varying voltage to the electrolyser, whilst monitoring the current load. The voltage may be varied in different ways. As shown here, a step change in voltage value is applied to the electrolyser from its rated voltage VR to approximately 90% of V_{R} (it is to be noted that the scale of the Y-axis is not a true representation of values) A 10% voltage reduction is only illustrative and other values may be applicable. The applied voltage reduction may be introduced to the electrolyser as a fast reduction in voltage (square wave) or as a more gradual change to the voltage (ramp) to ensure that voltage is not too sudden while at the same time being fast enough to record a dynamic response in the current.

The reduced voltage level may be applied for a predetermined period of time, shown here as between T0 and T1, before being increased back to the rated voltage level V_{R}. More than one voltage excursion may be applied to the electrolyser. The example in FIG. 6 shows a square wave application of voltage, but it should be noted that this is just for illustration only and other voltage variations could be used. For example, a sinusoidal voltage variation could be applied.

The voltage variation may be applied at a range of different frequencies. One option would be for the voltage variation to be applied in a frequency range of between 1 Hz and 200 Hz. However, it is also envisaged that frequencies above 1 kHz could be used.

During the application of the voltage variation, the condition monitoring system 100 is configured to measure the current flowing into and out of the electrolyser, as shown in step 304. Based on the varying voltage and current, the monitoring system 100 is further configured to determine the impedance of the electrolyser as a function of the frequency of voltage variation, i.e. the time-domain voltage. Without wishing to be bound by theory, it is believed that the insight gained by quantifying the impedance of the electrolyser over a range of dynamic voltage conditions can provide a more accurate understanding of the performance or health of the electrolyser so that more informed maintenance actions can be carried out, or recommended.

The variable voltage may be applied during a specific testing phase for the electrolyser rather than during steady state operation. In other examples, it is envisaged that the configuration of the variable voltage may be selected so that the appropriate data can be obtained whilst not affecting the operation of the electrolyser.

The electrolyser is a complex electrochemical device which over time is known to degrade in energy efficiency. The method disclosed herein provides a means to monitor capacitance and impedance of the electrolyser over time which in addition to stack resistance can be used to monitor the state of the electrolyser. Based on this data, preventative actions may be taken in due time to avoid further degradation or by scheduling preventive service.

In all of the first, second and third use case examples discussed above, the monitoring of the electrolyser is carried out on the entire electrolyser. However, there may be further benefit in carrying out the monitoring algorithms whilst operating the electrolyser on a partial load basis, that is, operating only a subset of the individual cells 40 of the electrolyser 30 as discussed above in relation to FIG. 3. This is believed to provide the opportunity to assess at a more detailed or granular level the physical condition of the cells in the electrolyser stack. The benefit of this is that it allows decisions to be made about which cells 40 should be given priority during operation. For example, certain ones of the plurality of electrolyser cells 40 that are determined to be providing reduced performance, and thereby more degraded compared with other ones of the cells 40, may be prioritised for operation when the electrolyser is being run on a partial load basis.

In all of the performance monitoring use cases discussed above, the metrics determined thereby may be fed into a electrolyser model in order better to assess the health of the electrolyser.

In the above discussion, it should be appreciated that the condition monitoring system 100 may determine the operational parameters of the electrolyser, for example the parameters of voltage, current, frequency, based on any suitable source of data. For example, the condition monitoring system 100 may monitor the input electrical terminals of the electrolyser 30 with suitable voltage and current sensors to derive the necessary measurements of voltage, current and frequency. In an alternative example, however, the condition monitoring system 100 may receive suitable electrical data from the control system 36 of the power converter system 22 from which at least one of the operational parameters of the electrolyser may be determined. Since the control system 36 is responsible for controlling the power converter system to provide sufficient power to the electrolyser 30 for effective operation, the control system 36 may be configured to output or provide readings/measurements/data to the condition monitoring system 100 of the electrical parameters that it generates for control of the electrolyser, principally voltage, current and the associated frequency where a variable input electrical load is applied, as discussed above. This provides an elegant solution for derivation of the operational parameters because it avoids the need for further sensing system hardware, firmware and software since the required data is available already from the control system 36.

In the above discussion, it will be appreciated that the control system 36 and the condition monitoring system 100 are described as separate functional systems. However, this is for convenience of illustration only. It is envisaged that in appropriate circumstances the hardware and/or software functionality of the control system 36 of the power converter system 22 and the condition monitoring system 100 may be providing on the same computing environment, e.g. in the same computing cabinet within the nacelle of the wind turbine, and on the same or related processor boards. Likewise, any control functions specific to the electrolyser that may not be shown here may also be provided on the same computing environment.

1. A hydrogen generation system comprising:
a hydrogen electrolyser;
a power converter connected to the electrolyser, and a control system configured to control the power converter to supply power to the electrolyser,
a monitoring system configured to monitor the operation of the generation system, wherein the monitoring system is configured to:
determine a plurality of operational parameters of the electrolyser, and,
generate one or more performance metrics based on the determined operational parameters, the one or more performance parameters including:
the electrical capacitance of the electrolyser, and/or the equivalent series resistance of the electrolyser.

2. The hydrogen generation system of claim 1, wherein the one or more performance parameters further includes:
a time-domain voltage level of the electrolyser as a function of current.

3. The hydrogen generation system of claim 2, wherein the monitoring system is further configured to generate an impedance value of the electrolyser as a function of frequency, based on the time-domain voltage level of the electrolyser.

4. The hydrogen generation system of claim 1, wherein the monitoring system is configured to determine the electrical capacitance of the electrolyser by:
determining an amount of charge delivered to the electrolyser during a pre-charge phase.)

5. The hydrogen generation system of claim 1, wherein the electrical resistance is determined as a function of electrical current, electrolyser temperature and electrolyser pressure during steady-state operation.

6. The hydrogen generation system of claim 1, wherein the monitoring system is configured to generate one or more advisory actions based on the one or more performance metrics.

7. The hydrogen generation system of claim 6, wherein the one or more advisory actions relates to at least one of an anode component, a cathode component and an electrolyte component of the electrolyser.

8. The hydrogen generation system of claim 1, wherein at least one of the operational parameters is determined by obtaining data from the control system of the power converter.

9. A method for determining the operational performance of a hydrogen generation system, the system including a hydrogen electrolyser and a power converter connected to the electrolyser, the method comprising:
determining a plurality of operational parameters of the electrolyser, and,
generating one or more performance metrics based on the determined operational parameters, the one or more performance parameters including:
the electrical capacitance of the electrolyser, and/or the equivalent series resistance of the electrolyser.

10. The method of claim 9, wherein the one or more performance metrics further includes:
a time-domain voltage level of the electrolyser as a function of current.

11. The method of claim 10, further comprising: generating an impedance value of the electrolyser as a function of frequency, based on the time-domain voltage level of the electrolyser.

12. The method of claim 9, further comprising determining the electrical capacitance of the electrolyser by:
determining an amount of charge delivered to the electrolyser during a pre-charge phase.

13. The method of claim 9, wherein the electrical series resistance is determined as a function of electrical current, electrolyser temperature and electrolyser pressure during steady-state operation.

14. The method of claim 8, further comprising: generating one or more advisory actions based on the one or more performance metrics.

15. The method of claim 14, wherein the one or more advisory actions relates to at least one of an anode component, a cathode component and an electrolyte component of the electrolyser.

16. The method of claim 9, wherein at least one of the operational parameters is determined by obtaining data from the control system of the power converter.
